(19) United States
(12) Patent Application Publication
(10) Pub. No.: US 2026/0064575 A1
(43) Pub. Date: Mar. 5, 2026

(54) METHOD AND SYSTEM OF TESTING A FINE-TUNED LLM FOR DOMAIN SPECIFIC CODE GENERATION

(71) Applicant: HCL Technologies Limited, New Delhi (IN)

(72) Inventors: Arun Singh, Bengaluru (IN); Yogesh Gupta, Noida (IN); Harikrishna Warrier, Bengaluru (IN)

(21) Appl. No.: 19/084,851

(22) Filed: Mar. 20, 2025

(30) Foreign Application Priority Data
Sep. 2, 2024 (IN) 202411066137

(51) Int. Cl. G06F 11/3668; G06F 8/35

(52) U.S. Cl. CPC G06F 11/3688; G06F 8/35

(57) ABSTRACT

A method and system of testing a fine-tuned LLM for domain specific code generation is disclosed. Further, a processor receives a test dataset corresponding to a domain from a code repository. Further, the processor determines an LLM generated problem statement corresponding to the test code using the fine-tuned LLM. The fine-tuned LLM is fine-tuned based on a training dataset. Further, the fine-tuned LLM is prompted based on the LLM generated problem statement to determine an LLM generated code for a corresponding test function. The accuracy level of the fine-tuned LLM is determined based on a percentage match between the LLM generated code with the test code for each of the set of test functions.

### TECHNICAL FIELD

This disclosure relates generally to evaluating large language models, and more particularly to method and system for testing a fine-tuned LLM for domain specific code generation.

### BACKGROUND

While deploying large language models (LLM) in a private environment, it is essential to train the model using different datasets or training data. The trained LLMs may not be accurate when used to generate codes for a specific dataset for creation of a domain based codebase. Therefore, reliance on the trained LLMs for generation of domain specific code requires evaluation of the trained LLMs in order to ensure the efficiency and precision of the generated codes. Since, effectiveness of the LLMs heavily relies on the quality and diversity of training data which may be sparsely available in private environments.

Conventionally existing code datasets are often too general and not tailored to specific domains or codebases, leading to less effective evaluations. Current datasets are static and cannot easily adapt to new domains or evolving codebases, leading to outdated or irrelevant evaluations. Thus, LLMs that are trained generate codes for certain domain-specific codebases, when evaluated on general datasets, may not perform well thus, reducing their practical effectiveness. Therefore, there is a need for an efficient method and system for testing a fine-tuned LLM for domain specific code generation.

### SUMMARY OF THE INVENTION

In an embodiment, a method of testing a fine-tuned large language model (LLM) is disclosed. The method may include receiving, by a processor a test dataset corresponding to a domain from a code repository. In an embodiment, the test dataset may include a set of test functions and a test code corresponding to each test function of the set of test functions., The method may further include determining, by the processor, for each of the set of test functions, an LLM generated problem statement based on the corresponding test code using the fine-tuned LLM. In an embodiment, the fine-tuned LLM may be fine-tuned based on a training dataset corresponding to the domain. The method may further include prompting, by the processor, for each of the set of test functions, the fine-tuned LLM based on the LLM generated problem statement to determine an LLM generated code for a corresponding test function. The method may further include determining, by the processor, an accuracy level of the fine-tuned LLM based on a percentage match between the LLM generated code with the test code for each of the set of test functions.

In another embodiment, a system for testing a fine-tuned large language model (LLM) is disclosed. The system may include a processor, and a memory communicably coupled to the processor. The memory may store processor-executable instructions, which when executed by the processor, may cause the processor to receive a test dataset corresponding to a domain from a code repository. In an embodiment, the test dataset may include a set of test functions and a test code corresponding to each test function of the set of test functions. For each of the set of test functions, the processor may determine an LLM generated problem statement based on the corresponding test code using the fine-tuned LLM. In an embodiment, the fine-tuned LLM may be fine-tuned based on a training dataset corresponding to the domain. For each of the set of test functions, the processor may further prompt the fine-tuned LLM based on the LLM generated problem statement to determine an LLM generated code for a corresponding test function. Further, the processor may determine an accuracy level of the fine-tuned LLM based on a percentage match between the LLM generated code with the test code for each of the set of test functions.

In another embodiment, a non-transitory computer-readable medium storing computer-executable instructions for testing fine-tuned large language models (LLM) is disclosed. In one example, the stored instructions, when executed by a processor, may cause the processor to perform operations including receiving a test dataset corresponding to a domain from a code repository. In an embodiment, the test dataset may include a set of test functions and a test code corresponding to each test function of the set of test functions. The operations may further include, for each of the set of test function, determining an LLM generated problem statement, based on the corresponding test code using the fine-tuned LLM. In an embodiment, the fine-tuned LLM may be fine-tuned based on a training dataset corresponding to the domain. The operations may further include prompting the fine-tuned LLM, based on the LLM generated problem statement to determine an LLM generated code for a corresponding test function. Further, the operations may include determining an accuracy level of the fine-tuned LLM, based on a percentage match between the LLM generated code with the test code for each of the set of test functions.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of a system for testing a fine-tuned LLM for domain specific code generation, in accordance with an embodiment of the present disclosure.

FIG. 2 is a functional block diagram of a computing device of the system of FIG. 1, in accordance with an embodiment of the present disclosure.

FIG. 3 illustrates an exemplary training dataset, in accordance with an embodiment of the present disclosure.

FIG. 4 illustrates a flowchart of a method of testing a fine-tuned LLM, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

As explained earlier, large language models may be trained to generate code for domain-specific code datasets. However, the existing datasets are broad with respect to domain and may not be able to capture the distinctive features of specific domains, which may in turn limit the efficiency and usability of such models for domain-specific applications. Further, the LLMs may be fine-tuned to generate code for domain specific dataset. Also to ensure that the fine-tuned LLMs are efficient they are required to be tested. The present disclosure provides a methodology of testing a fine-tuned LLM for domain specific code generation.

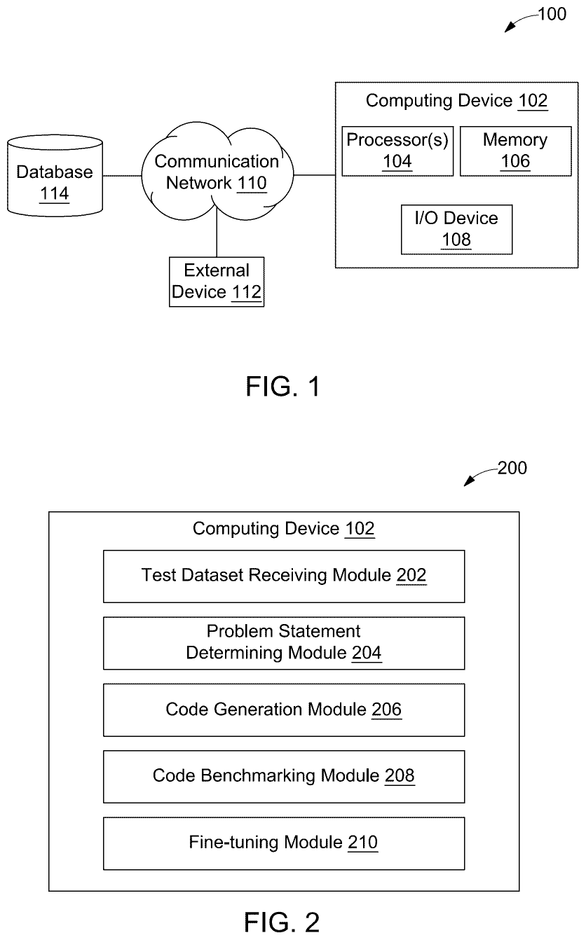

Referring now to FIG. 1, a block diagram of a system 100 for testing a fine-tuned LLM for domain specific code generation is illustrated, in accordance with an embodiment of the present disclosure. The system 100 may include a computing device 102, an external device 112, and a database 114 communicably coupled to each other through a wired or wireless communication network 110. The computing device 102 may include a processor 104, a memory 106 and an input/output (I/O) device 108.

In an embodiment, examples of processor(s) 104 may include but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors.

In an embodiment, the memory 106 may store instructions that, when executed by the processor 104, and cause the processor 104 to test a fine-tuned LLM for domain specific code generation, as will be discussed in greater details herein below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may include a variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the database 114 may be enabled in a remote cloud server or a co-located server. In an embodiment, the database 114 may store an application, a large language model (LLM), and other data necessary for the system 100 to perform testing. In an embodiment, the database 114 may store data input by an external device 112 (e.g., prompts) or output generated by the computing device 102. In an embodiment, examples of LLM may include llama series, Falcon series, etc. It is to be noted that the application may be designed and implemented as either a web application or a software application. The web application may be developed using a variety of technologies such as HTML, CSS, JavaScript, and various web frameworks like React, Angular, or Vue.js. It may be hosted on a web server and accessible through standard web browsers. On the other hand, the software application may be a standalone program installed on users' devices, which may be developed using programming languages such as Java, C++, Python, or any other suitable language depending on the platform. In an embodiment, the computing device 102 may be communicably coupled with the database 114 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the communication network 110 can include a variety of network devices, including routers, bridges, servers, computing devices, storage devices, and the like.

In an embodiment, the computing device 102 may test the fine-tuned LLM for domain specific code generation based on an input received from the external device 112 through the communication network 110. In an embodiment, the computing device 102 and external device 112 may be a computing system, including but not limited to, a smart phone, a laptop computer, a desktop computer, a notebook, a workstation, a server, a portable computer, a handheld, or a mobile device. In an embodiment, the computing device 102 may be, but not limited to, in-built into the external device 112 or may be a standalone computing device.

In an embodiment, the computing device 102 may perform various operations in order to test the fine-tuned LLM for domain specific code generation. By way of an example, the computing device 102 may receive a test dataset corresponding to a domain from a code repository. In an embodiment, the test data may be extracted from the code repository based on a Python script. In an embodiment, the code repository may be user-defined and may include domain specific test dataset defined by the user. In an embodiment, the test dataset may include a set of test functions and a test code corresponding to each of the test function of the set of functions. In an embodiment, the test code may be generated upon extracting the test functions from the test dataset using the python script from the code repository. Further, the test dataset may be specific to a particular domain, examples of the domain may include but are not limited to medical, data science, telecommunication, etc.

The computing device 102 may further determine for each of the set of test functions, an LLM generated problem statement based on the corresponding test code using the fine-tuned LLM. In an embodiment, the fine-tuned LLM may be fine-tuned based on a training dataset corresponding to the domain. In an embodiment, the training dataset corresponding to the domain may include a set of predefined functions, a predefined code, and a prompt corresponding to each predefined function from the set of predefined functions, and a test case corresponding to each of the predefined code for each of the set of predefined functions. In an embodiment, the fine-tuned LLM may be fine-tuned based on the training dataset using in-context learning techniques. The in-context learning may involve training the fine-tuned LLM by prompting a small set of data from the corresponding training dataset at inference time. The fine-tuned LLM may learn from the small set of data and may further be fine-tuned based on the in-context learning.

Further, the computing device 102, may prompt the fine-tunned LLM based on the LLM generated problem statement to determine an LLM generated code for the corresponding test functions for each of the set of test functions. In an embodiment, the fine-tuned LLM may use a reverse technique to determine LLM-generated code from the LLM-generated problem statement, which may itself be derived from the test code corresponding to the test dataset. Further, the computing device 102 may determine an accuracy level of the fine-tuned LLM based on a percentage match between the LLM generated code with the test code for each of the set of test functions. In an embodiment, the test code may act as a ground truth code for the LLM generated code to determine the accuracy level of the fine-tuned LLM.

The computing device 102 may further determine a test assert corresponding to the LLM generated code for each of the set of test functions. In an embodiment, results of the test assert may be used to determine the accuracy of the LLM generated code with respect to the test code.

Further, the computing device 102 may include updating the training dataset with the LLM generated code that may be about same as the test code for a corresponding predefined function from the set of predefined functions. The computing device 102 may further fine-tune the LLM based on the updated training dataset using pre-defined fine-tuning techniques.

FIG. 2 illustrates a functional block diagram of the computing device 102, in accordance with an embodiment of the present disclosure. FIG. 2 is explained in conjunction with FIG. 1. In an embodiment, the computing device 102 may include a test dataset receiving module 202, a problem statement determining module 204, a code generation module 206, code benchmarking module 208, and a fine-tunning module 210.

The test dataset receiving module 202 may receive the test dataset corresponding to a domain from a code repository of the domain. Examples of domain may include data science, banking, e-commerce, telecom, etc. In an embodiment, the test dataset may include the set of test functions and the test code corresponding to each test function of the set of test functions. In an embodiment, the set of text functions may correspond to the domain. The test dataset may be extracted from the code repository based on a python script. In an aspect, the python script for each code repository for each of the domains may be predefined and may be run based on the requirement. In an embodiment, a code repository specific to a domain that may store code and other software development assets for example tests, and scripts related to various functions.

Further, the problem statement determining module 204 may determine an LLM generated problem statement for each of the set of test functions based on the corresponding test code using the fine-tuned LLM. In an embodiment, the LLM generated problem statement may include a clear description of the problem with the relevant data required to generate relevant code. In an embodiment, the fine-tuned LLM may be fine-tuned based on a training dataset corresponding to the domain. In an embodiment, the fine-tuned LLM may be fine-tuned based on the training dataset using in-context learning techniques. In an embodiment, the training dataset corresponding to the domain may include a set of predefined functions, a predefined code and a prompt corresponding to each predefined function from the set of predefined functions, and the test case corresponding to each of the predefined code for each of the set of predefined functions. The fine-tuned LLM may apply in-context learning based on the training dataset to learn and understand the dataset features, and mutual dependencies of features, and accordingly the LLM may be fine-tuned LLM for the domain specific training dataset.

Further, the code generation module 206 may determine the LLM generated code for the corresponding test function. The determination of the LLM generated code may be achieved by prompting the fine-tuned LLM using the LLM generated problem statement for the corresponding test function as explained above. In an embodiment, the fine-tuned LLM may apply in-context learning to the LLM generated problem statement to determine the LLM generated code. In in-context learning, the LLM may be prompted using the LLM generated problem statement and may use examples or instructions in the LLM generated problem statement as instructions and based on which the LLM may output the code. An exemplary prompt used for enabling the LLM to perform in-context learning and apply the in-context learning to generate LLM generated code for each of the set of predefined functions is as follows:
prompt=f”””
Task1: your task is read the dataset and do in-context learning. \how features are related to each other
dataset:
   ‘‘‘{DATASET}’’’
Task2: now as you have already learnt about dataset, \n
You have to create ‘canonical_solution’ actual code for implementation and name of the function \n
from the given prompt, return output in tabular format, follow standard code format rule, the test data is given as below.
test_data:
‘‘‘{problemStatement}’’’
output format is
“canonical_solution”: “actual code in python” ”””

Further, the code benchmarking module 208 may determine the accuracy level of the fine-tuned LLM based on a percentage match between the LLM generated code with the test code for each of the set of test functions. In an embodiment, the fine-tuned LLM may benchmark the LLM generated code with the test code for each of the set of test functions by comparing the LLM generated code and the test code by using pre-existing benchmarking techniques. In an embodiment, the benchmarking may be done by determining test asserts corresponding to the LLM generated code for each of the set of test functions. Accordingly, the accuracy level of the fine-tuned LLM may be determined.

Further, the fine-tuning module 210, may update the training dataset with the LLM generated code that may be about same as the test code for a corresponding predefined function from the set of predefined functions. In an embodiment, the updated training dataset based on the LLM generated code may further be used to fine-tune the fine-tuned LLM. The fine-tuning of the LLM may include pre-existing approaches, a few examples may include but are not limited to a feature extraction approach also known as repurposing approach to fine-tune LLM and full fine-tuning approach.

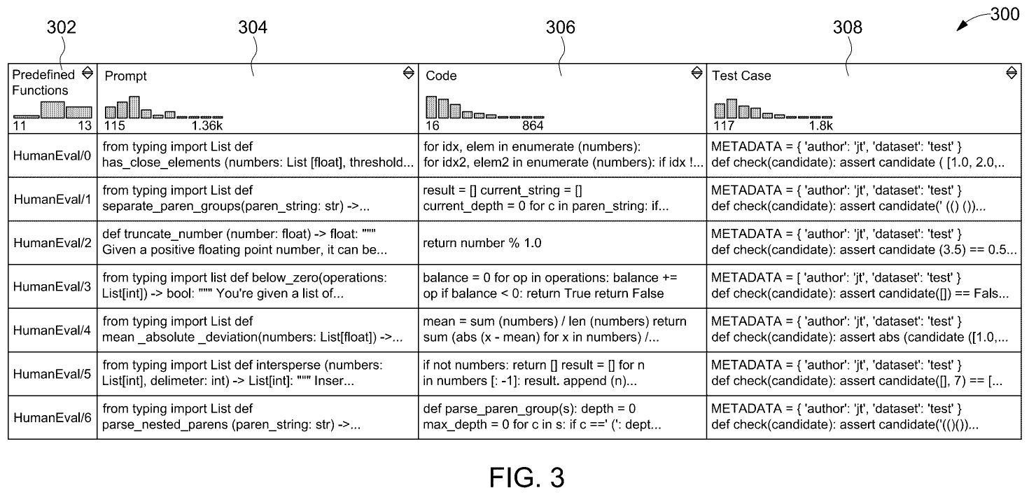

Referring now to FIG. 3, an exemplary training dataset 300 for fine-tuning the LLM is illustrated, in accordance with an embodiment of the present disclosure. The exemplary training dataset 300 may a table including a column each for listing a set of predefined functions 302, prompts 304, a predefined code 306, and test case 308 corresponding to each of the set of predefined functions 302.

The exemplary training dataset 300 may be used to train or fine-tune the LLM in order for the LLM to be able to generate code for the corresponding domain. In an embodiment, the set of predefined functions 302 may be same as the set of test functions as extracted from the code repository using the Python script. Further, the prompts 304 may include instructions and examples to perform the desired task by the fine-tuned LLM. Further, the training dataset 300 may include the predefined code 306 and the test case 308 corresponding to each of the predefined code 306 for each of the predefined function 302. In an embodiment, the predefined code 306 may be user provided or inputted code for the corresponding predefined function in a predefined programming language. Further, in an embodiment, the test case 308 may be defined to test functionality of the predefined code 306. The test case 308 may include a certain set of conditions that need to be checked to test the predefined code 306 of the training dataset 300.

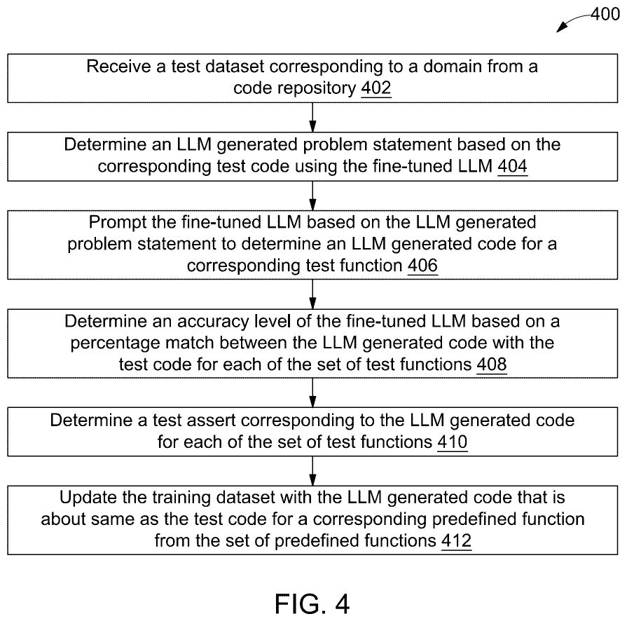

Referring to FIG. 4, a flowchart 400 of a method of testing a fine-tuned LLM for domain specific code generation is disclosed, in accordance with an embodiment of the present disclosure. In an embodiment, the method may include a plurality of steps. Each step of the method may be executed by various modules, same as the modules 202-210 of the computing device 102 so as to test a fine-tuned LLM for domain specific code generation.

At step 402, the computing device 102 may receive a test dataset corresponding to a domain from a code repository. Examples of domain may include data science, data analytics, telecom, e-commerce, etc. In an embodiment, the code repository may be a predefined code repository corresponding to the domain. In an embodiment, the test dataset may include a set of test functions and a test code corresponding to each test function of the set of test functions.

At step 404, for each of the set of test functions, the computing device 102 may further determine an LLM generated problem statement based on the corresponding test code using the fine-tuned LLM. In an embodiment, the LLM generated problem statement may include a brief description of the issue that may be solved by the corresponding test code. It is to be noted that the fine-tuned LLM may be fine-tuned based on the training dataset 300 corresponding to the domain. The training dataset 300 may include the set of predefined functions 302, the predefined codes 306, and the prompts 304 corresponding to each predefined function from the set of predefined functions 302, and the test case 308 corresponding to each of the predefined code 306 for each of the set of predefined functions 302.

At step 406, the computing device 102 may prompt the fine-tuned LLM based on the LLM generated problem statement to determine the LLM generated code for the corresponding test function. Further, at step 408, the computing device 102 may determine an accuracy level of the fine-tuned LLM based on a percentage match between the LLM generated code with the test code for each of the set of test functions. Accordingly, the fine-tuned LLM may be benchmarked for generation of code for the domain based on the accuracy level determined. In one embodiment, different benchmarking methods may be used to evaluate the efficiency and performance of the fine-tuned LLM for generation of code for the domain.

Further at step 410, the computing device 102 may determine the test assert corresponding to the LLM generated code for each of the test functions. In an embodiment, results of the test assert may be used to the accuracy of the LLM generated code with respect to the test code. At step 412, the computing device 102 may update the training dataset 300 with the LLM generated code that may be about same as the test code for the corresponding predefined function from the set of predefined functions 302.

Thus, the disclosed method and system try to overcome the technical problem of testing the fine-tuned LLM for domain specific code generation. In an embodiment, advantages of the disclosed method and system may include but is not limited to improved accuracy in the evaluation of the code generation model that may lead to more reliable results and better performance. The disclosed method and system may generate unit test cases for the code without exposing it to unauthorized parties. Further, the test cases may help to ensure the quality and reliability of the code. The disclosed method and system may enable an LLM to create a domain-specific dataset that is more relevant to the code repository of the domain and allows improvement in the accuracy and applicability of the fine-tuned LLM for automatic generation of codes for specific domains.

As will be appreciated by those skilled in the art, the techniques described in the various embodiments discussed above are not routine, or conventional, or well-understood in the art. The techniques discussed above provide for testing a fine-tuned LLM for domain specific code generation.

It is intended that the disclosure and examples be considered as exemplary only, with a true scope of disclosed embodiments being indicated by the following claims.

What is claimed is:

1. A method of testing a fine-tuned large language model (LLM), comprising:
receiving, by a processor, a test dataset corresponding to a domain from a code repository,
wherein the test dataset comprises a set of test functions and a test code corresponding to each test function of the set of test functions;
for each of the set of test functions:
determining, by the processor, an LLM generated problem statement based on the corresponding test code using the fine-tuned LLM,
wherein the fine-tuned LLM is fine-tuned based on a training dataset corresponding to the domain; and
prompting, by the processor, the fine-tuned LLM based on the LLM generated problem statement to determine an LLM generated code for a corresponding test function; and
determining, by the processor, an accuracy level of the fine-tuned LLM based on a percentage match between the LLM generated code with the test code for each of the set of test functions.

2. The method of claim 1, further comprises:
determining, by the processor, a test assert corresponding to the LLM generated code for each of the set of test functions.

3. The method of claim 2, wherein the training dataset corresponding to the domain comprises a set of predefined functions, a predefined code and a prompt corresponding to each predefined function from the set of predefined functions, and a test case corresponding to each of the predefined code for each of the set of predefined functions.

4. The method of claim 1, wherein the test dataset is extracted based on a python script from the code repository.

5. The method of claim 1, wherein the fine-tuned LLM is fine-tuned based on the training dataset using in-context learning techniques.

6. The method of claim 1, comprising:
updating, by the processor, the training dataset with the LLM generated code that is about same as the test code for a corresponding predefined function from the set of predefined functions.

7. A system for testing a fine-tuned large language model (LLM), comprising:
a processor; and
a memory communicably coupled to the processor, wherein the memory stores processor-executable instructions, which when executed by the processor, cause the processor to:
receive a test dataset corresponding to a domain from a code repository,
wherein the test dataset comprises a set of test function and a test code corresponding to each test function of the set of test functions;
for each of the set of test functions:
determine an LLM generated problem statement based on the corresponding test code using the fine-tuned LLM,
wherein the fine-tuned LLM is fine-tuned based on a training dataset corresponding to the domain; and
prompt the fine-tuned LLM based on the LLM generated problem statement to determine an LLM generated code for a corresponding test function; and
determine an accuracy level of the fine-tuned LLM based on a percentage match between the LLM generated code with the test code for each of the set of test functions.

8. The system of claim 7, wherein the processor-executable instructions cause the processor to:
determine a test assert corresponding to the LLM generated code for each of the set of test functions.

9. The system of claim 8, wherein the training dataset corresponding to the domain comprises a set of predefined functions, a predefined code, and a prompt corresponding to each predefined function from the set of predefined functions, and a test case corresponding to each of the predefined code for each of the set of predefined functions.

10. The system of claim 7, wherein the test dataset is extracted based on a Python script from the code repository.

11. The system of claim 7, wherein the fine-tuned LLM is fine-tuned based on the training dataset using in-context learning techniques.

12. The system of claim 7, wherein the processor is further configured to update the training dataset with the LLM generated code that is about same as the test code for a corresponding predefined function from the set of predefined functions.

13. A non-transitory computer-readable medium storing computer-executable instructions for testing a fine-tuned large language model (LLM), the stored instructions, when executed by a processor, cause the processor to perform operations comprising:
receiving a test dataset corresponding to a domain from a code repository,
wherein the test dataset comprises a set of test functions and a test code corresponding to each test function of the set of test functions;
for each of the set of test functions:
determining an LLM generated problem statement, based on the corresponding test code using the fine-tuned LLM,
wherein the fine-tuned LLM is fine-tuned based on a training dataset corresponding to the domain; and
prompting the fine-tuned LLM, based on the LLM generated problem statement to determine an LLM generated code for a corresponding test function; and
determining an accuracy level of the fine-tuned LLM, based on a percentage match between the LLM generated code with the test code for each of the set of test functions.

14. The non-transitory computer-readable medium of claim 13, wherein the stored instructions, when executed by the processor, cause the processor to perform operations comprises:
determining a test assert corresponding to the LLM generated code for each of the set of test functions.

15. The non-transitory computer-readable medium of claim 14, wherein the training dataset corresponding to the domain comprises a set of predefined functions, a predefined code and a prompt corresponding to each predefined function from the set of predefined functions, and a test case corresponding to each of the predefined code for each of the set of predefined functions.

16. The non-transitory computer-readable medium of claim 13, wherein the test dataset is extracted based on a python script from the code repository.

17. The non-transitory computer-readable medium of claim 13, wherein the fine-tuned LLM is fine-tuned based on the training dataset using in-context learning techniques.

18. The non-transitory computer-readable medium of claim 13, wherein the stored instructions, when executed by the processor, cause the processor to perform operations comprising:
updating the training dataset with the LLM generated code that is about same as the test code for a corresponding predefined function from the set of predefined functions.
